(19) United States
(12) Patent Application Publication
(10) Pub. No.: US 2009/0015956 A1
(43) Pub. Date: Jan. 15, 2009

(54) Method and Apparatus for Coupling a Microelectromechanical System Scanner Mirror to a Frame

(75) Inventor: Joshua LIU, Roselle, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/775,379

(22) Filed: Jul. 10, 2007

(51) Int. Cl. G02B 7/182

(52) U.S. Cl. 359/874; 359/873

(57) ABSTRACT

Formation of a biaxial microelectromechanical system (MEMS) scanner can comprise, at least in part, providing a frame (11) having an aperture (14) formed therethrough, wherein the frame has a first pair of axially aligned flexures (12 and 13) about which the frame can selectively pivot. A scan mirror (41) can then be operably coupled to this frame by a second pair of axially aligned flexures (42 and 43). By one approach, this scan mirror is disposed co-extensive with but external to the aperture in the frame.

### TECHNICAL FIELD

This invention relates generally to microelectromechanical systems (MEMS) and more particular to a MEMS-based scanner.

### BACKGROUND

MEMS-based structures of various kinds are known in the art. Such structures, though sometimes also configured to leverage corresponding electromagnetic, electrostatic, piezoelectric, and/or optical behaviors, often comprise small machines of various kinds including, for example, pivotable and/or rotating beams and members of various kinds. This includes the fabrication of MEMS-based scanners having small mirrored surfaces that can be selectively moved to thereby support, for example, the provision of various retinal scanning displays and imaging applications, to note but two examples in this regard.

A paper entitled “Two-Axis Electromagnetic Microscanner for High Resolution Displays” as authored by Arda Yalcinkaya et al. and as published in the Journal of Microelectromechanical Systems, Vol. 15, No. 4 (August 2006) (referred to hereinafter as the Yalcinkaya paper) describes a MEMS-based scanner having a small scan mirror that can be moved with respect to both a first and a second axis along with various other construction details and operational instructions. The corresponding scanner has a number of desirable operational behaviors and advantages as compared to a variety of other approaches in this regard. The teachings of the Yalcinkaya paper will likely be adequate for a variety of application purposes.

This does not mean, however, that the apparatus described in the Yalcinkaya paper will be adequate for all anticipated application purposes. Though offering a small form factor, the resultant scanner is potentially relatively tall as compared to other components with which it may be employed. This height results, in part, due to a need to accommodate both an X-axis and a Y-axis flexture axis of movement for the scan mirror. The physical requirements that are seemingly necessary to support this design requirement tend to suggest that this height requirement cannot be bettered.

### BRIEF DESCRIPTION OF THE DRAWINGS

The above needs are at least partially met through provision of the method and apparatus for coupling a microelectromechanical system scanner mirror to a frame described in the following detailed description, particularly when studied in conjunction with the drawings, wherein:

FIG. 1 comprises a schematic perspective view as configured in accordance with the prior art;

FIG. 2 comprises a side elevational schematic view as configured in accordance with the prior art;

FIG. 3 comprises a flow diagram as configured in accordance with various embodiments of the invention;

FIG. 4 comprises a schematic perspective view as configured in accordance with various embodiments of the invention; and

FIG. 5 comprises a schematic side elevational view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, formation of a biaxial microelectromechanical system (MEMS) scanner can comprise, at least in part, providing a frame having an aperture formed therethrough, wherein the frame has a first pair of axially aligned flexures about which the frame can selectively pivot. A scan mirror can then be operably coupled to this frame by a second pair of axially aligned flexures. By one approach, this scan mirror is disposed co-extensive with but external to the aperture in the frame.

By disposing the scan mirror external to the aperture in this way, it becomes possible to attach the scan mirror's flexures to an external surface of the frame that is relatively distal to the aperture. This, in turn, makes it possible to now considerably reduce the height (or the width, if desired) of the frame as the size of the aperture no longer must have a size sufficient to accommodate both the scan mirror and the required lengths of its opposing flexures. So configured, a corresponding MEMS-based scanner can have all of the advantages of the Yalcinkaya paper approach while nevertheless also offering the benefits of a considerably reduced form factor dimension (such as height or width). Those skilled in the art will understand and appreciate that this, in turn, will permit the resultant scanner to be employed in application settings that might otherwise have been unsuitable for a Yalcinkaya paper-based apparatus.

These and other benefits may become clearer upon making a thorough review and study of the following detailed description. Referring now to the drawings, and in particular to FIG. 1, it may be helpful for the reader to first further elaborate upon certain relevant teachings of the Yalcinkaya paper. This paper discloses a scanner 10 comprised of a frame 11 having a first pair of axially aligned flexures 12 and 13 that extend outwardly of the frame 11 on opposing sides. These flexures 12 and 13 permit movement, and particularly rotational movement Θ₂, in support of forming what is denoted in the Yalcinkaya paper as the slow-scan axis. This frame 11 also has an aperture 14 formed therethrough.

This scanner 10 also comprises a scan mirror 15 having a circular shape in this illustrative embodiment. This scan mirror 15 has a second pair of axially aligned flexures 16 and 17 which are disposed normal to the first pair of axially aligned flexures 12 and 13 as correspond to the frame 11. The scan mirror 15 is disposed co-extensive with and internal to the frame aperture 14. The end portions of the second pair of axially aligned flexures 16 and 17 are attached to the frame 11 and permit movement, and particularly rotational movement 0 (and hence Θ₁), in support of forming what is denoted in the Yalcinkaya paper as the fast-scan axis.

The frame 11 can be prompted to desired movement using any of a variety of motive forces, including but not limited to electrostatic forces, electromagnetic forces, and piezoelectric forces, as desired. By one approach (and as noted in the Yalcinkaya paper), this frame 11 can be provided with a multi-turn spiral coil 18 to facilitate controlling relative movement of these components with respect to these axes of movement. Further details are provided in the Yalcinkaya paper regarding the deployment, control, and use of this scanner 10. These details are especially relevant here and therefore, for the sake of brevity, are not set forth. The complete contents of the Yalcinkaya paper are, however, fully incorporated herein by this reference.

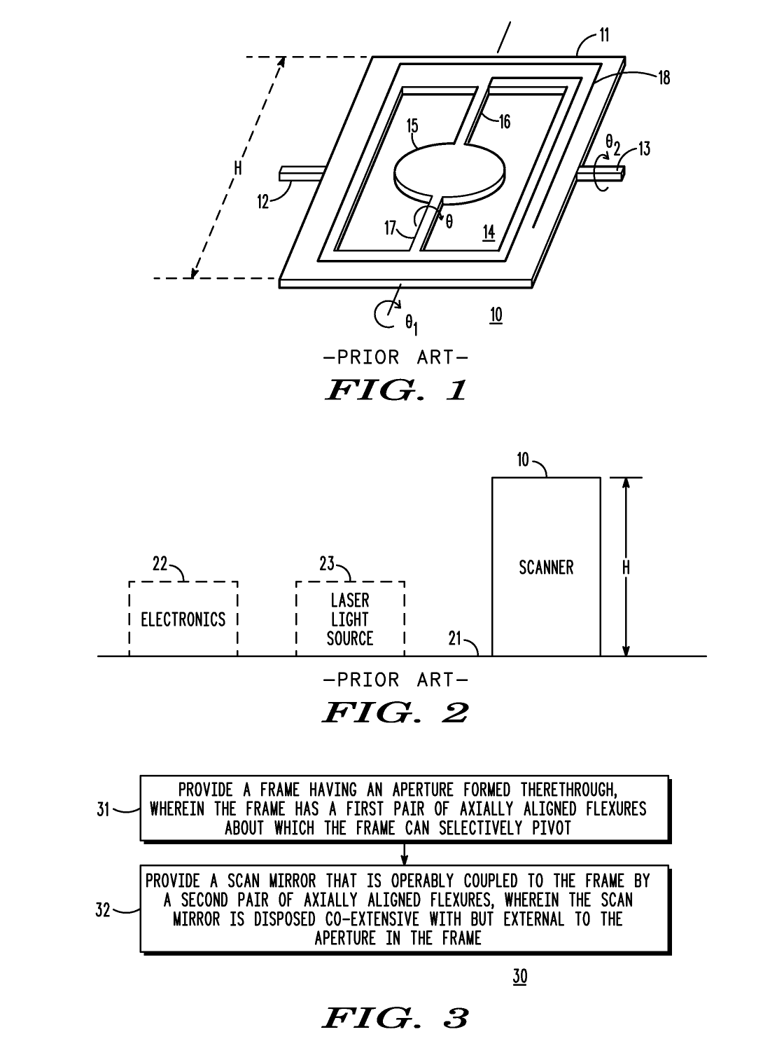

This scanner 10 has a corresponding height H. With reference to FIG. 2, this height H can exceed the height of other components that may be used in conjunction with such a scanner 10. For example, as illustrated, the scanner 10 may be mounted or otherwise formed on a common substrate 21 with corresponding electronics 22 and a corresponding laser light source 23. In cases where the latter two components 22 and 23 have a smaller profile than the described scanner 10, the height H of the scanner 10 becomes the determining factor for determining a minimum overall height of the combined structure.

The present teachings provide a way of reducing the height requirement for such a scanner.

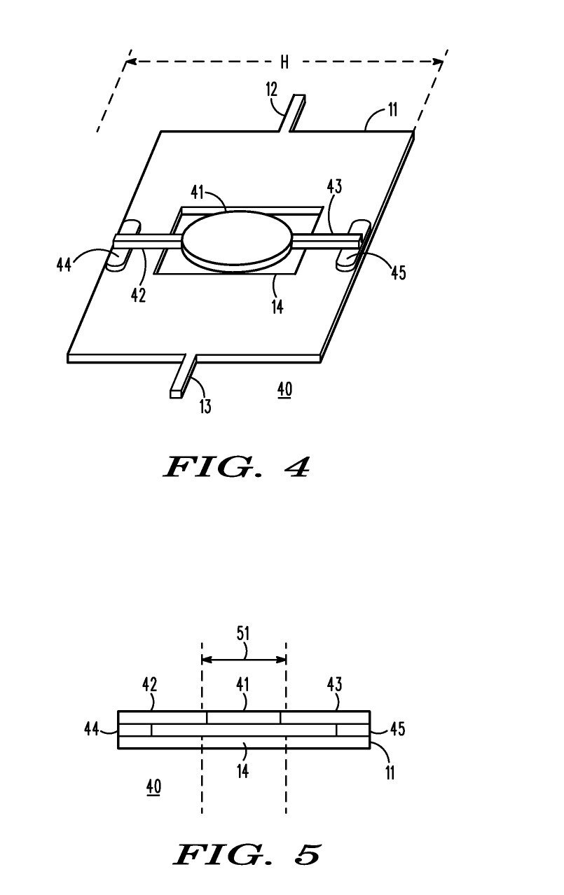

Referring now to FIGS. 3, 4, and 5, an illustrative process 30 suitable to represent at least certain of these teachings will be described. Pursuant to this process to facilitate forming a biaxial microelectromechanical system (MEMS) scanner, one again provides 31 a frame 11 having an aperture 14 formed therethrough, wherein the frame 11 has a first pair of axially aligned flexures 12 and 13 about which the frame 11 can selectively pivot. Generally speaking, this tends to accord with the teachings of the Yalcinkaya paper. In this case, however, the aperture 14 is smaller than the aperture required by the Yalcinkaya paper. The benefits of this will be made clearer below.

This frame 11 and its flexures 12 and 13 can be comprised of any suitable material (such as silicon) and can be formed using any MEMS-based fabrication technique of choice as may presently be known or which may be developed hereafter. This frame 11 can also comprise a multi-turn spiral coil as was noted and presented above.

This process 30 then provides 32 a scan mirror 41 that is operably coupled to the frame 11 by a second pair of axially aligned flexures 42 and 43. This scan mirror 41 and it's flexures 42 and 43 can be comprised of, for example, one or more of silicon, copper, aluminum, or other material of choice.

As with the Yalcinkaya paper teachings, this second pair of axially aligned flexures 42 and 43 are disposed substantially perpendicular to the first pair of axially aligned flexures 12 and 13. Also as with the Yalcinkaya paper, this scan mirror 41 is again disposed co-extensive with the aperture 14. With momentary specific reference to FIG. 5, those skilled in the art will recognize and understand that this means that the scan mirror 41 lies fully within the outwardly-extended periphery 51 of the aperture 14.

Unlike the teachings of the Yalcinkaya paper, however, in this case the scan mirror 41 is disposed external to the aperture 14 in the frame 11. By one approach, this can comprise connecting opposing ends of the second pair of flexures 42 and 43 to the frame 11 via corresponding posts 44 and 45. These posts 44 and 45 serve, at least in part, to elevate the flexures 42 and 43 such that a substantial portion of these flexures 42 and 43 does not contact the frame 11. This, in turn, serves to maintain the scan mirror 42 in a different layer than the frame 11. Although this multi-layer approach yields a resultant scanner 40 having a slightly thicker form factor than the scanner 10 disclosed in the Yalcinkaya paper, this also permits fabrication of a scanner 40 having a considerably reduced height H as compared to the Yalcinkaya paper scanner 10.

As per the teachings of the Yalcinkaya paper, it can be important to ensure that the second pair of flexures 43 and 44 are of a sufficient length to meet the requirements of the Yalcinkaya paper's natural mode operational performance. This, in turn, does seem to impose a limit on reducing the height H of this style of scanner. Nevertheless, where the Yalcinkaya paper scanner may require, for example, a scanner height of at least 5.0 mm, the present teachings can serve to provide a scanner of essentially identical performance while having a scanner height of only 3.6 mm. This represents a height reduction of approximately twenty-eight percent which can, in turn, prove the difference between a viable form factor for certain application settings and one that is unacceptable.

Those skilled in the art will recognize and understand that these teachings are readily scaled as appropriate and provide a very feasible, economical, and powerful means for leveraging the teachings of the Yalcinkaya paper. In particular, those skilled in the art will recognize and appreciate that these present teachings are readily practiced using any of a variety of known and well-understood MEMS fabrication techniques and practices.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the disclosed two-layer scanner structure can not only be fabricated using silicon MEMS technology as indicated in the Yalcinkaya paper, but can also be fabricated using other materials including, for example, metals such as copper, aluminum, and nickel films with corresponding actuation mechanisms.

We claim:

1. A method to facilitate forming a biaxial microelectromechanical system (MEMS) scanner comprising:
providing a frame having an aperture formed therethrough, wherein the frame has a first pair of axially aligned flexures about which the frame can selectively pivot;
providing a scan mirror that is operably coupled to the frame by a second pair of axially aligned flexures, wherein the scan mirror is disposed co-extensive with but external to the aperture in the frame.

2. The method of claim 1 wherein providing a scan mirror that is operably coupled to the frame by a second pair of axially aligned flexures comprises providing a scan mirror that is operably coupled to the frame by a second pair of axially aligned flexures that are disposed substantially perpendicular to the first pair of axially aligned flexures.

3. The method of claim 1 wherein providing a scan mirror that is operably coupled to the frame by a second pair of axially aligned flexures comprises connecting opposing ends of the second pair of axially aligned flexures to the frame.

4. The method of claim 3 wherein connecting opposing ends of the second pair of axially aligned flexures to the frame comprises connecting the opposing ends of the second pair of axially aligned flexures to the frame such that a substantial portion of the second pair of axially aligned flexures do not contact the frame.

5. The method of claim 1 wherein providing a frame comprises providing a frame that comprises a multi-turn spiral coil.

6. The method of claim 1 wherein providing a frame comprises providing a frame comprised substantially of silicon.

7. The method of claim 6 wherein providing a scan mirror comprises providing a scan mirror comprised substantially of at least one of:
silicon;
copper;
aluminum.

8. The method of claim 1 wherein the first pair of axially aligned flexures comprise a slow-scan axis and the second pair of axially aligned flexures comprise a fast-scan axis.

9. An apparatus comprising a microelectromechanical system (MEMS) component, the apparatus comprising:
a frame having an aperture formed therethrough, wherein the frame has a first pair of axially aligned flexures about which the frame can selectively pivot;
a scan mirror that is operably coupled to the frame by a second pair of axially aligned flexures, wherein the scan mirror is disposed co-extensive with but external to the aperture in the frame.

10. The apparatus of claim 9 wherein the second pair of axially aligned flexures are disposed substantially perpendicular to the first pair of axially aligned flexures.

11. The apparatus of claim 9 wherein the scan mirror is attached to the frame by connections at opposing ends of the second pair of axially aligned flexures.

12. The apparatus of claim 11 wherein a substantial portion of the second pair of axially aligned flexures does not contact the frame.

13. The apparatus of claim 9 wherein the frame comprises a multi-turn spiral coil.

14. The apparatus of claim 13 wherein the frame is comprised substantially of silicon.

15. The apparatus of claim 14 wherein the scan mirror is comprised substantially of at least one of:
silicon;
copper;
aluminum.

16. The apparatus of claim 9 wherein the first pair of axially aligned flexures comprise a slow-scan axis and the second pair of axially aligned flexures comprise a fast-scan axis.
